(19) United States
(12) Patent Application Publication
(10) Pub. No.: US 2024/0114269 A1
(43) Pub. Date: Apr. 4, 2024

(54) CABLE MANAGEMENT TRAY

(71) Applicant: The Lan Wirewerks Research Laboratories Inc., Quebec (CA)

(72) Inventor: Simon VIGNEAULT, Quebec (CA)

(73) Assignee: The Lan Wirewerks Research Laboratories Inc., Quebec (CA)

(21) Appl. No.: 18/274,505

(22) PCT Filed: Jan. 27, 2022
(86) PCT No.: PCT/CA2022/050111

§ 371 Date: Jul. 27, 2023

Related U.S. Application Data
(60) Provisional application No. 63/142,204, filed on Jan. 27, 2021.

(51) Int. Cl. H04Q 1/06; G02B 6/44; H04Q 1/02

(52) U.S. Cl. CPC H04Q 1/064; G02B 6/44526; H04Q 1/023

(57) ABSTRACT

The present invention provides a system for managing and storing cables comprising a storage tray slidably mounted in a housing enclosure for coiling, spooling and/or storing cables of various lengths. The cable management system of the present invention minimizes or eliminates cable strain during technician access and cable storage. Located within the tray are elements including a routing system comprising spooling elements and cable guiding walls configured to define compartments for storage of the cables and cable routing paths. The tray further comprises cable openings extending along both sides of the tray configured to allow a portion of the cable length to extend from the muting elements and out the side of the tray. The cable management system also comprises two cable guides maintain the cable in a fixed position relative to the side of the housing when the tray is moved.

### TECHNICAL FIELD

The invention relates to a cable management tray system.

### BACKGROUND OF THE ART

Cable and optical fiber management trays are designed for cable and fiber muting, cable strain relief, fiber slack handling and protection, and fiber splice tray accommodation. Such fiber management trays are typically mounted in modular optical fiber panels or racks.

Like most aspects of fiber cable management, management trays must ideally be configured to meet a number of requirements to ensure reliability and durability of the fiber network, including ensuring that a minimum bend radius is maintained in the tray.

One way of ensuring minimum bend radius is to provide routing paths, which are typically designed so that the cables can only be routed properly by technicians. Further, the accessibility to the fibers installed or stored in a tray is important to ensure proper bend radius and correct routing over time, and the cables must be protected from physical damages.

While there exist optical fiber management trays, most of them are complex, create tension and/or are otherwise unsatisfactory. Therefore, it would be desirable to be provided with an improved optical fiber management tray system.

### SUMMARY OF THE INVENTION

An object of the present invention is to provide a cable management tray. In accordance with an aspect of the present invention, there is provided a cable management tray system comprising: a. an enclosure comprising a first side wall and a second side wall, each of the first and second side walls having a front end and a back end; b. a first cable guide and a second cable guide, each said cable guide being configured to guide a portion of the cable; and c. a tray slidably mounted to the enclosure and movable between an open position and a closed position, the tray having a front end, a back end, a first side and a second side, the tray comprising: i. a bottom wall; ii. a routing system comprising one or more spooling elements mounted on the bottom wall, the routing system being configured to retain a portion of a cable length received on the tray when the tray is moved between the open and the closed position; and iii. a first cable opening extending along the first side of the tray and a second cable opening extending along the second side of the tray, each of the first and second cable openings extending between the front end and the back end of the tray, each cable opening allowing a portion of the cable length to extend from the routing element to a respective cable guide to slide relative to the front end and back end as the tray is moved between the open position and the closed position.

### BRIEF DESCRIPTION OF THE DRAWINGS

Having thus generally described the nature of the invention, reference will now be made to the accompanying drawings, showing by way of illustration example embodiments thereof and in which:

FIG. 1 is a top perspective view of a cable management tray system, in accordance with one embodiment;

FIG. 2 is a bottom rear perspective view of the cable management tray system shown in FIG. 1;

FIG. 3 is a top plan view of the cable management tray system shown in FIG. 1;

FIG. 4 is a bottom plan view of the cable management tray system shown in FIG. 1;

FIG. 5 is a front view of the cable management tray system shown in FIG. 1;

FIG. 6 is a back view of the cable management tray system shown in FIG. 1;

FIG. 7 is a left side view of the cable management tray system shown in FIG. 1;

FIG. 8 is a right side view of the cable management tray system shown in FIG. 1;

FIG. 9 is a top front perspective view of an enclosure for the cable management tray shown in FIG. 1 with a left slide in extended position attached thereto, in accordance with one embodiment;

FIG. 10 is a bottom front perspective view of the enclosure shown in FIG. 9;

FIG. 11 is a top view of the enclosure shown in FIG. 9;

FIG. 12 is a bottom view of the enclosure shown in FIG. 9;

FIG. 13 is a front view of the enclosure shown in FIG. 9:

FIG. 14 is a back view of the enclosure shown in FIG. 9;

FIG. 15 is a left side view of the enclosure shown in FIG. 9:

FIG. 16 is a right view of the enclosure shown in FIG. 9;

FIG. 17 is a top front perspective view of a right side wall for the enclosure shown in FIG. 9, with a right side bracket and cable guide attached thereto, in accordance with one embodiment;

FIG. 18 is a top front perspective and exploded view of the right side wall, right side bracket and cable guide shown in FIG. 17;

FIG. 19 is a back exploded view of the right side wall, right side bracket and cable guide shown in FIG. 17;

FIG. 20 is a top back perspective and exploded view of the right side wall, right side bracket and cable guide shown in FIG. 17;

FIG. 21 is a top front perspective view of the cable guide shown in FIG. 17;

FIG. 22 is a top front perspective view of a tray for the cable management tray shown in FIG. 1 with a left slide in extended position attached thereto, in accordance with one embodiment;

FIG. 23 is a bottom back perspective view of the tray shown in FIG. 22;

FIG. 24 is a top view of the tray shown in FIG. 22;

FIG. 25 is a bottom view of the tray shown in FIG. 22;

FIG. 26 is a front view of the tray shown in FIG. 22;

FIG. 27 is a back view of the tray shown in FIG. 22;

FIG. 28 is a left side view of the tray shown in FIG. 22;

FIG. 29 is a right side view of the tray shown in FIG. 22;

FIG. 30 is a top perspective view of a spooling element, in accordance with one embodiment;

FIG. 31 is a bottom perspective view of the spooling element shown in FIG. 31;

FIGS. 32A and 32B are top perspective views of a cable management tray system mounted to vertical members of a rack in accordance with one embodiment, in closed position (FIG. 32A) and open position (FIG. 32B);

FIGS. 33A and 33B are top perspective views of a cable management tray system mounted to vertical members of a rack with a cable contained in a storage compartment and extending through funneled openings in accordance with one embodiment, in closed position (FIG. 33A) and open position (FIG. 33B);

FIGS. 34A and 34B are schematic representations of the slack in the cable as the tray moves in the enclosure between the closed position (FIG. 34A) and the open position (FIG. 34B); and

FIG. 35 is a top perspective view of a cable management tray system, in accordance with another embodiment;

FIG. 36 is a left side perspective view of the cable management tray system shown in FIG. 35;

FIG. 37 is a top perspective view of a cable management tray system, in accordance with still another embodiment, showing the tray in an open position;

FIG. 38 is a top plan view of the cable management tray system shown in FIG. 37;

FIG. 39 is another top perspective view of the cable management tray system shown in FIG. 37, with the tray in a closed position;

FIG. 40 is another top perspective view of the cable management tray system shown in FIG. 37, showing the tray in an open position and a cable length coiled in accordance with another embodiment:

FIG. 41 is another top perspective view of the cable management tray system shown in FIG. 37, showing the tray in an open position and a cable length coiled in accordance with still another embodiment;

FIG. 42 is a top perspective view of a rack to which are mounted two cable management tray systems, in according with one embodiment;

FIG. 43 is another top perspective view of a rack to which are mounted two cable management tray systems, in accordance with another embodiment;

FIG. 44 is a top perspective view of a rack to which is mounted a cable management tray system and a telecommunication equipment, in accordance with one embodiment.

FIG. 45 is a top perspective view of a cable management tray system, in accordance with still another embodiment, showing the tray in an open position;

FIG. 46 is a top plan view of the cable management tray system shown in FIG. 45;

FIG. 47 is a top perspective view of the cable management tray system shown in FIG. 45, mounted on a rack, showing the tray in an open position; and

FIG. 48 is a top perspective view of the cable management tray system shown in FIG. 45, mounted on a rack, showing the tray in a closed position.

### DETAILED DESCRIPTION

The present invention provides a convenient system for managing and storing cables and optical fibers. The cable management system comprises a storage tray slidably mounted in a housing enclosure, wherein the tray is used for coiling, spooling and/or storing cables of various lengths. The cable management system of the present invention is configured to minimize or eliminate cable strain during technician access and cable storage.

Accordingly, located within the tray are compartments for storage of the cable(s), as well as features that are configured to provide cable routing paths, ensure that a minimum bend radius of the cable is maintained, and facilitate access for technicians to the cables coiled and/or stored therein.

Each tray within a respective housing enclosure comprises a routing system configured to retain a portion of a cable length received on the tray when the tray is moved between the open and the closed position. The routing system comprises one or more spooling elements mounted on the bottom of the tray. These spooling elements can be of any shape suitable to facilitate wrapping or spooling of the cable.

In a preferred embodiment, a plurality of spooling elements is employed. In one embodiment, the spooling elements of the routing system are located in a generally central area within the compartment of the tray.

The routing, or cable spooling, system located inside the tray allows the tray to slide between the open and closed positions without creating unwanted or unnecessary slack or looseness in the cable coiled about the routing, or cable spooling, system while also preventing tension on the cable as the tray is moved between the open and closed positions. The distance traveled by the tray between open and closed positions defines the tray translation. In one embodiment, the routing system is centered on an area that corresponds generally to the midpoint of the tray translation.

In one embodiment, the spooling elements are arranged in a symmetrical configuration relative to a centerline extending from the front to the back of the tray. In a further embodiment, the spooling elements are arranged in a symmetrical configuration relative to a line extending from side to side of the tray.

The tray further comprises cable openings extending along both sides of the tray, wherein the cable openings are configured to allow a portion of the cable length to extend from the routing elements and out the side of the tray. The cable openings allow the cable to slide relative to the front and back ends of the tray as the tray is moved between the open position and the closed position.

In a preferred embodiment, the cable management system further comprises two cable guides maintain the cable in a fixed position relative to the side of the housing when the tray is moved. In one embodiment, the cable guides are located at the front end of each side of the housing enclosure. The cable guides can be provided in any shape and size suitable to accommodate passage of the cables therethrough. It is within the scope of the present invention that the cable guides can be replaced with other structures or devices to secure the cable to the side brackets or other types of attachment points located generally at corresponding locations (e.g. .zip ties, clamps).

In one embodiment, the cable guide has the general shape of a rectangular loop in which is defined a cut or opening, for allowing a user to position or clamp a cable in the cable guide.

In a preferred embodiment, the tray is provided with two pairs of cable guiding walls for guiding and constraining the movement of the cables when the tray is moved between the open and closed position. A first pair of cable guiding walls is located adjacent to the back end of the tray and a second pair is located adjacent to the front end of the tray, wherein each guiding wall extends inwardly from the general area of a respective corner of the tray, toward the central area of the tray. In addition to guiding the movement of the cables, the guiding walls also provide a defined cable storage region within the tray.

Together, the back and front guiding walls define a funneled opening extending from the central region outwardly to the cable openings. The funneled opening together with the front and back guiding walls, allow a cable extending through a respective cable guide to move back and forth in the cable opening as the tray is moved between the retracted and open positions.

When the tray is moved from the open position to the closed position, the movement of the tray induces a slight, gradual, slack in the portions of the cable extending in the funneled openings until they reach a centrally aligned position, at which point further movement of the tray toward the closed position gradually reduces the slack, to reach back the initial tension in the cable, in the fully closed position, thanks to the frontward/backward symmetry of the left and right funneled openings.

The storage tray is slidable between an open position and a closed position. In one embodiment, when the tray is in the closed position, a major portion of the tray is contained or received in the enclosure. In one embodiment, the tray is configured to be located completely within the housing enclosure when in the closed position.

When the tray is in the open position, i.e., extending outside the housing enclosure, storage compartments within the tray are exposed to facilitate handling of the cable located within the tray (e.g., for coiling the cable about the spooling elements).

In another embodiment, a portion of the tray remains outside the housing enclosure when the tray is in the closed position. In such an embodiment, the system further comprises a pivotable tray cover that extends over the portion of the tray that is outside the housing. The pivotable cover can be opened in order to access the interior of the tray, In one embodiment, the cover is manufactured from a clear material so that the interior of the tray can be viewed while in the closed position.

The cable management trays are typically mounted in modular optical fiber panels or racks. Accordingly, in one embodiment, the cable storage management system further comprises a rack on which an enclosure containing a storage tray is mounted. In one embodiment, when multiple trays and enclosures are employed, they may be mounted in a stacked configuration. In another embodiment, the trays and enclosures may be mounted in a staggered configuration. In yet another embodiment, the trays and enclosures may be mounted in an alternating configuration, wherein each successive enclosure is mounted in an opposing orientation to the previous enclosure.

Throughout this application, the term “cable” should be given a broad meaning to include any type of cable, including without limitation any type of communication cable, electrical cable, optic fiber cable, Unshielded Twisted Pair (UTP) Cable, Shielded Twisted Pair (STP) Cable Coaxial Cable Unshielded Twisted Pair (UTP) Cable, Heliax cable, Non-metallic sheathed cable, Metallic sheathed cable, Multicore cable, Paired cable, Portable cord, Ribbon cable, Shielded cable, Single cable, Twinax cable, Twin-lead, Twisted pair and Submersible cable.

To gain a better understanding of the invention described herein, the following embodiments are set forth with reference to the accompanying drawings. It will be understood that these are intended to describe illustrative embodiments of the invention and are not intended to limit the scope of the invention in any way.

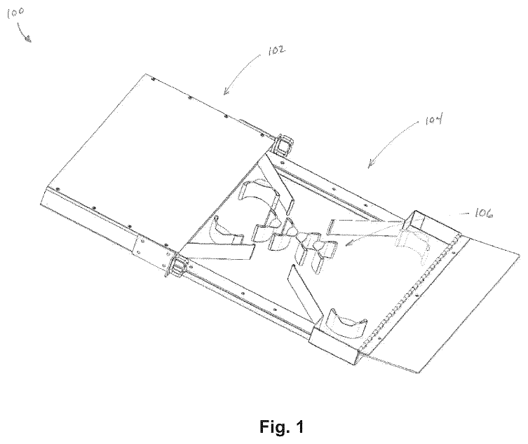

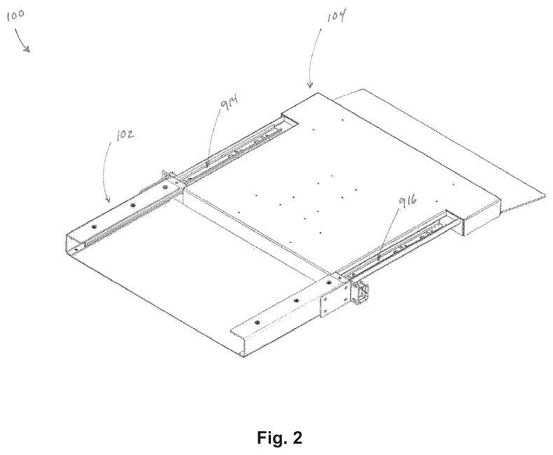

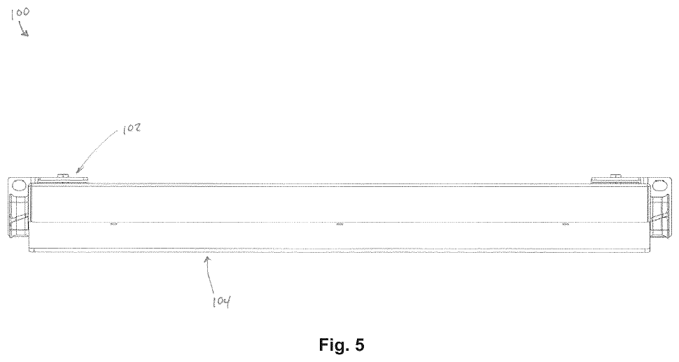

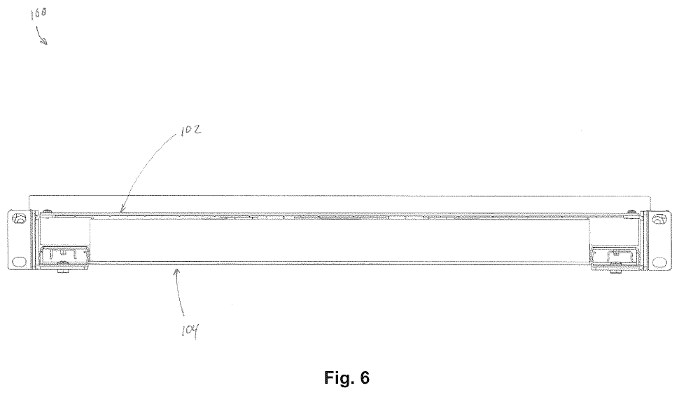

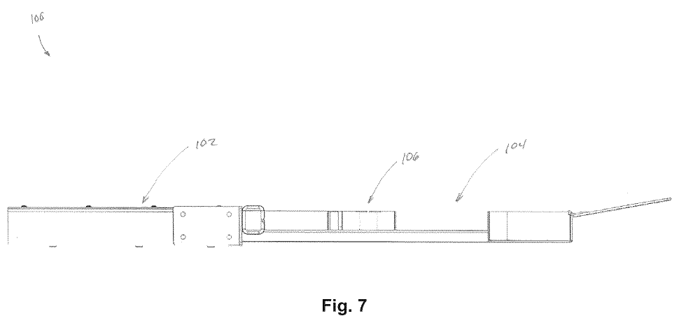

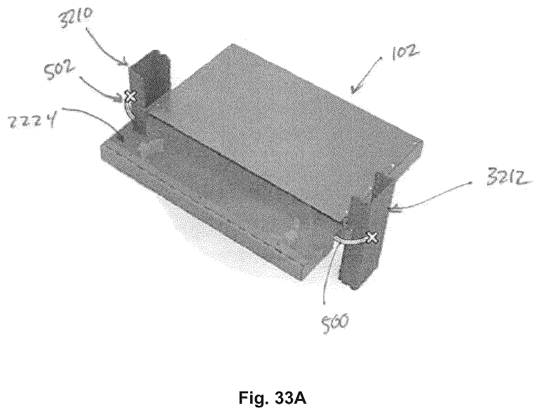

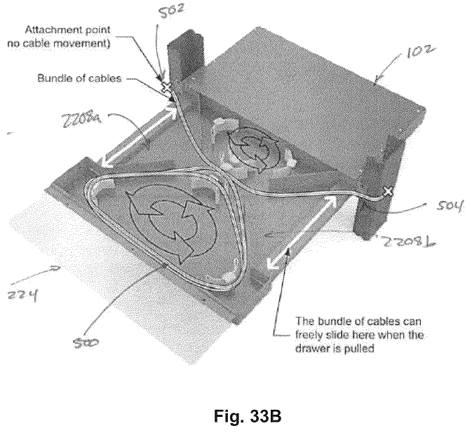

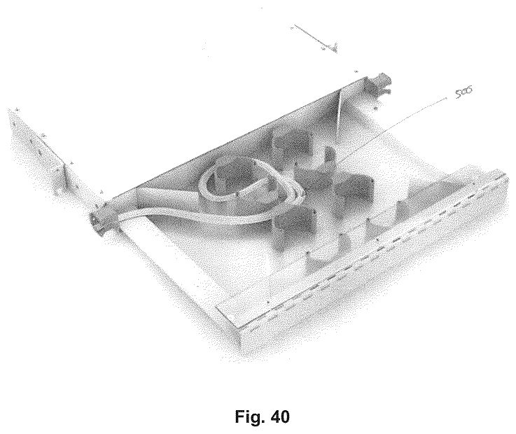

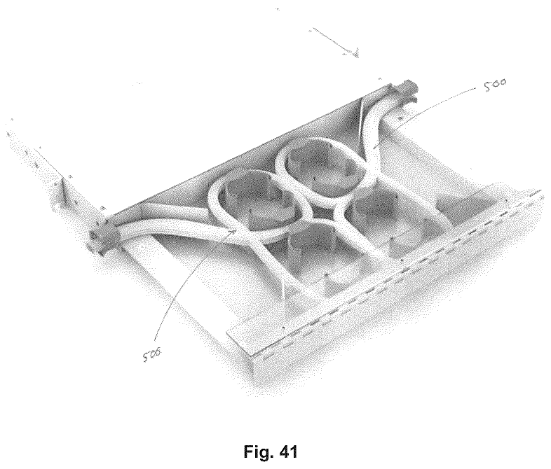

In accordance with one embodiment, and referring to FIGS. 1 to 8, there is provided an embodiment of a cable management tray system 100 in accordance with one embodiment. The cable management tray system 100 is used for coiling, spooling and/or storing cables of various lengths (e.g. cable length 500 shown in FIGS. 33A, 33B, 37, 38, 40 and 41), and includes features assisting in ensuring that a minimum bend radius of the cable is maintained, in providing cable routing paths, and in providing technicians with accessibility to the cables coiled and/or stored.

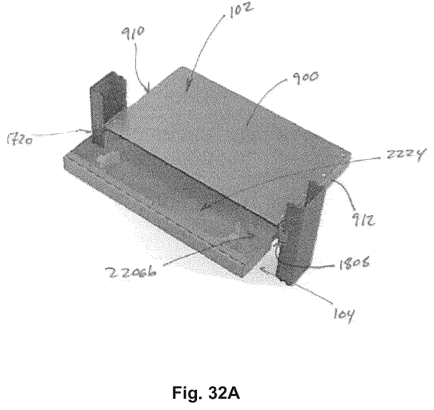

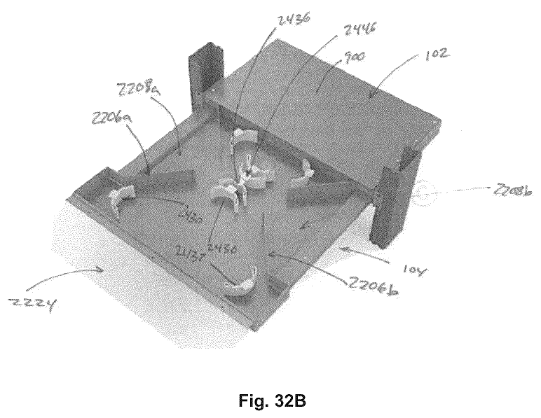

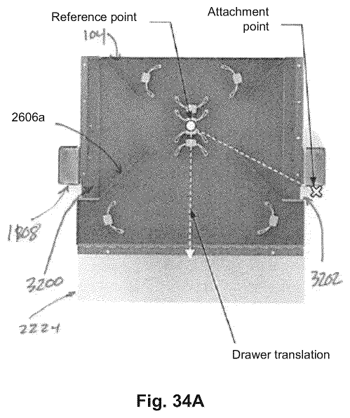

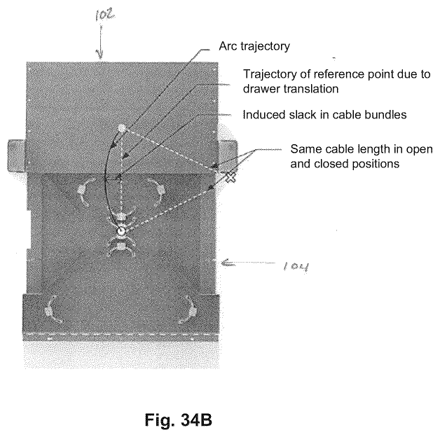

In this embodiment, the cable management tray system 100 generally corresponds to a 1U cable management tray and includes an enclosure 102 for mounting the tray 104 system 100 to a structure such as a telecommunication equipment rack (e.g. a 19-inch rack or a 23-inch rack—portions of the telecommunication equipment rack being shown in FIG. 32A to 34B) and configured for slidably receiving therein a drawer or tray 104. The tray 104 is provided with cables spooling system 106 (which will be described in greater details below) and is configured to reciprocate inside and outside of the enclosure 102, between a retracted (or closed) position (as best shown in FIGS. 32A, 33A and 34A) and an extended (or open) position (as best shown in FIGS. 1 to 9, and 32B, 33B and 34B). As it will become apparent below, the cable spooling system 106 is configured for allowing the tray 104 to slide between the open and closed positions without creating unwanted or unnecessary slack or loose in the cable 500 coiled about the cable spooling system 106 while preventing tension on the cable 500 as the tray 104 is moved between the open and closed positions.

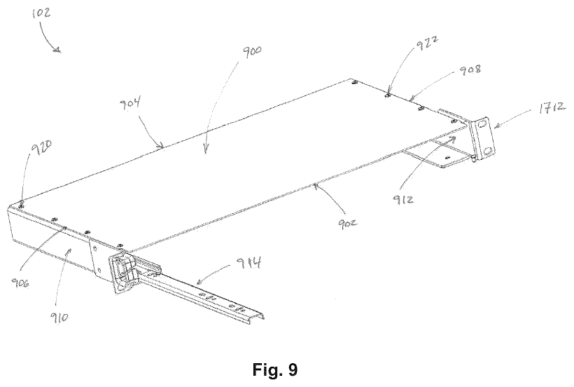

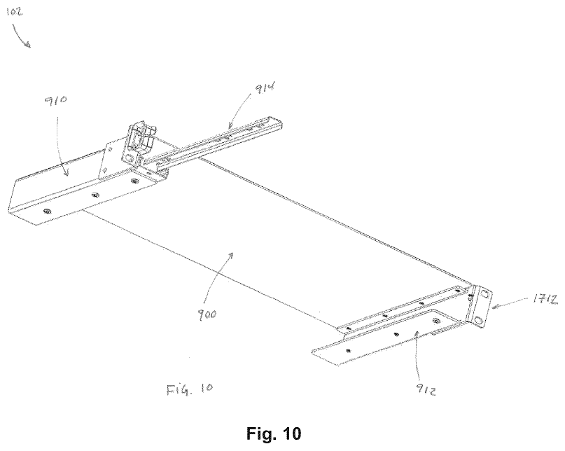

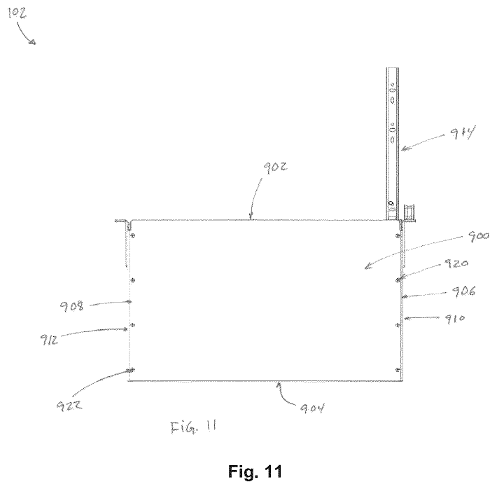

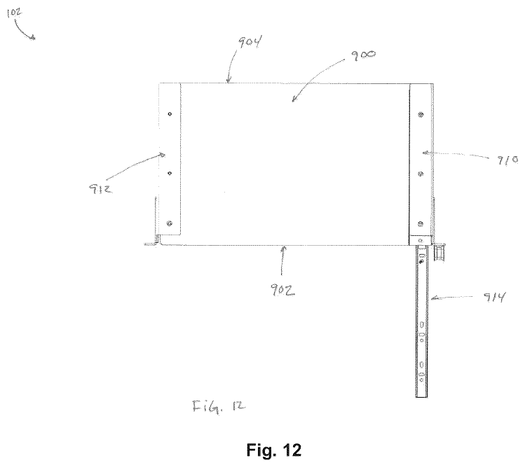

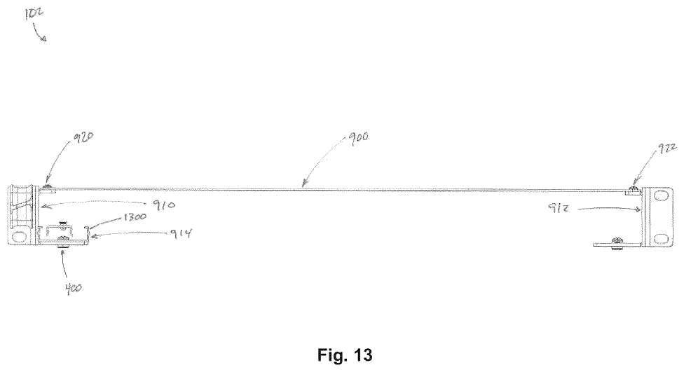

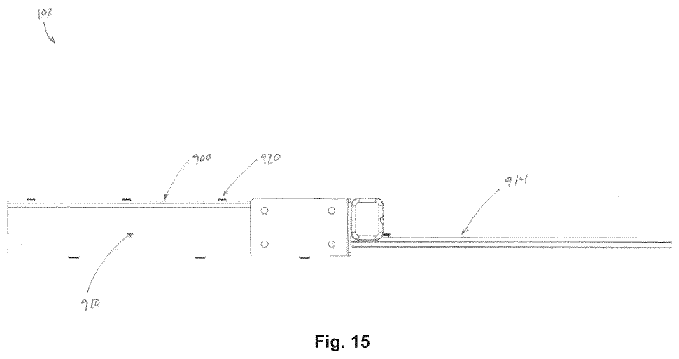

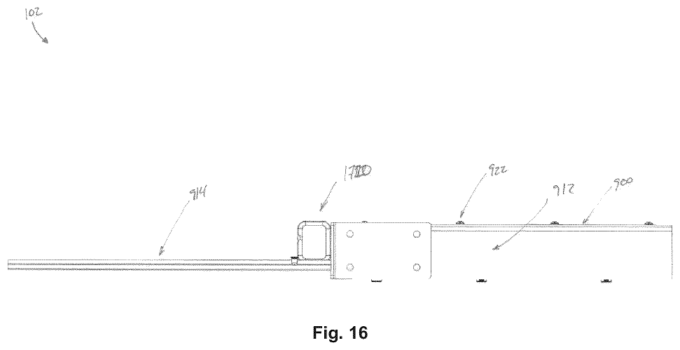

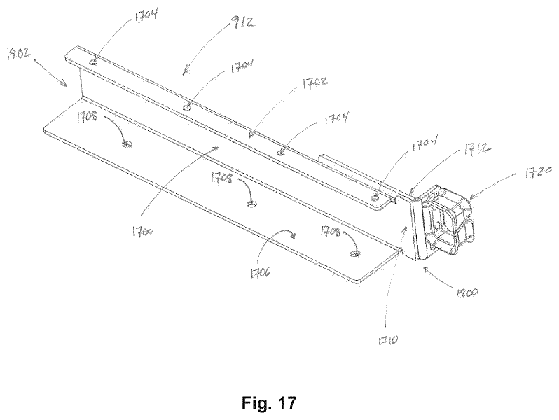

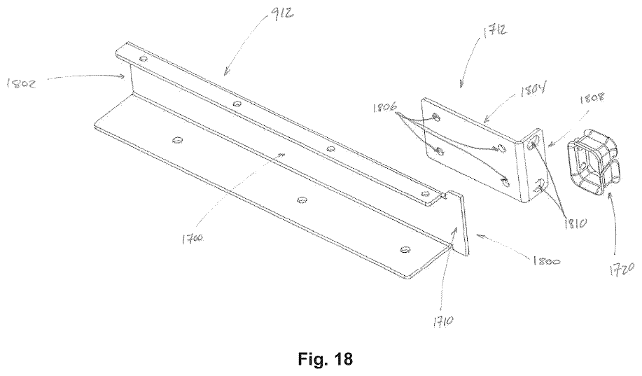

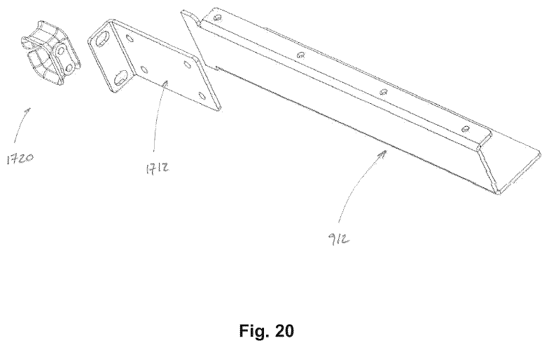

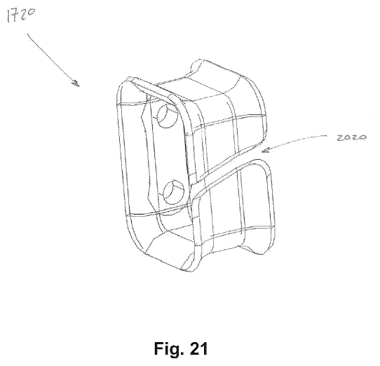

With reference to FIGS. 9 to 20, the enclosure 102 comprises a generally rectangular top wall 900 having front, back, left and right ends 902, 904, 906 and 908, respectively, as well as a pair of side walls 910, 912 extending downwardly from the top wall 900, at the left and right ends 906, 908 thereof, for supporting thereon left and right slides 914, 916 engaging the tray 104, as it will become apparent below. Left and right slides 914, 916 are preferably ball bearing slides, such as linear ball-bearing slides, roller bearing slides or progressive action slides. Defined proximal to the left and right ends 906, 908 of the top wall 900, and distributed between the front and back ends 902, 904 thereof, are pluralities of holes (not shown) for receiving therein corresponding pluralities of fasteners 920, 922, for securing the top wall 900 to the side walls 910, 912, as it will be described in greater details below.

The left and right side walls 910, 912 being mirror images of one another, only right side wall 912 will be described. It will be appreciated that a similar description also applies to left side wall 910, with proper adaptations.

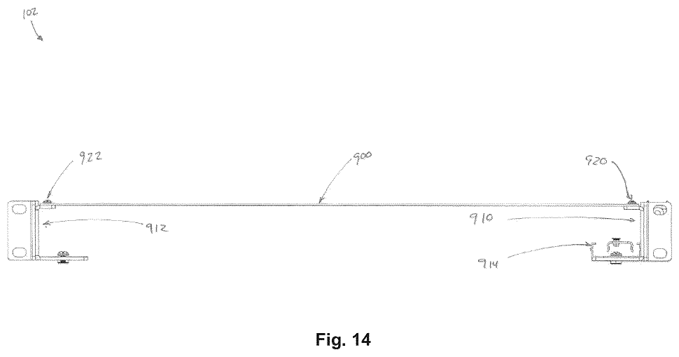

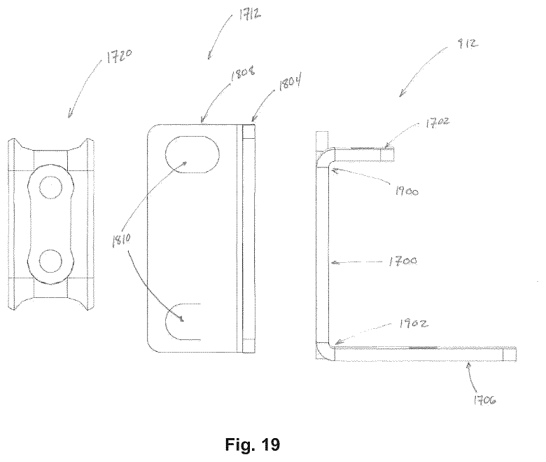

Right side wall 912 is generally L-shaped when seen from the back (see FIGS. 14 and 19 for instance) and comprises a vertical wall 1700 having a top end 1900 and a bottom end 1909, as well as a front end 1800 and a back end 1802. Extending at the top end 1900 of the vertical wall 1700, between the front and back ends 1800 and 1802, and perpendicular to the vertical wall, is a top flange 1702. The top flange 1702 is provided with a plurality of holes 1704, distributed between the front end 1800 and the back end 1802. The top flange 1702 of the right side wall 912 provides a supporting surface onto which the right end 908 of the top wall 900 rests to assemble the enclosure 102, and the holes 1704 defined on the top flange 1702 are positioned to align with the holes (not shown) of the top wall 900 and for receiving therein the corresponding plurality of fasteners 922 such as a bolt and nut assemblies, screws, rivet or the like, to therefore secure the top wall 900 to the top flange 1702 of the side wall 912.

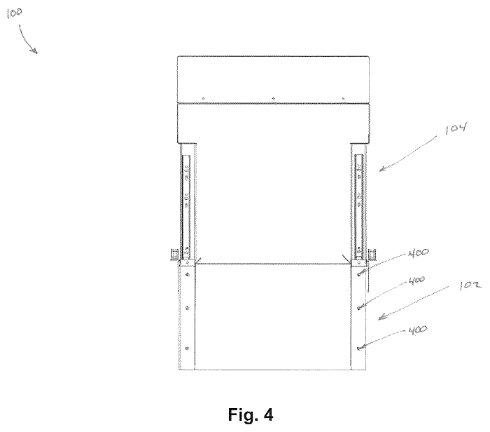

Extending at the bottom end 1902 of the vertical wall 1700, between the front and back ends 1800, 1802, and perpendicular to the vertical wall 1700 (and thus, parallel to the top flange), is a bottom flange 1706. The bottom flange 1706 is provided with a plurality of holes 1708, distributed between the front end 1800 and the back end 1802. The bottom flange 1706 of the right side wall 912 provides a supporting surface onto which the left slide assembly 916 rests to slidably mount the tray 104 to the enclosure 102, as it will be described in greater details below. In this regard, the holes 1708 defined on the bottom flange 1706 are positioned to align with corresponding holes (not shown) of the right slide assembly 916, for receiving therein fasteners 400 (shown in FIG. 4) such as a bolt and nut assemblies, screws, rivet or the like, for securing a first portion 1300 of the slide assembly 916 to the bottom flange 1706 of the right side wall 912. At the front end 1800 thereof, the right side wall 912 is provided with a frontwardly extending tab 1710 providing an abutment surface for securing a side bracket 1712 to the left side wall 912.

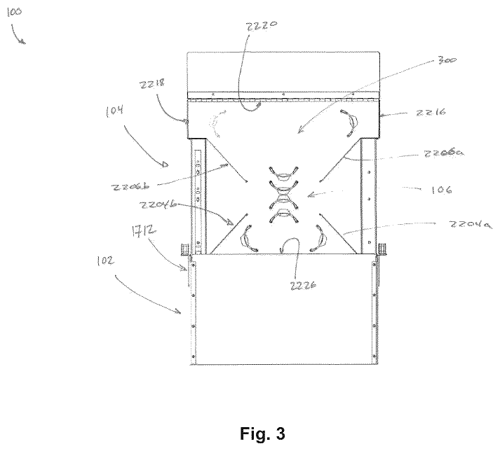

Mounted proximal at the front end 1800 of the left side wall 912, and resting against the forwardly extending tab 1710 and a portion of the vertical wall 1700, is the right side bracket 1712. When seen from the top (see e.g. FIG. 3), the right side bracket 1712 is generally L-shaped and comprises an enclosure mounting portion 1804 (resting against the forwardly extending tab 1710 and a portion of the vertical wall 1700) provided with a plurality of mounting holes 1806, for receiving fasteners (not shown) to secure the right side bracket 1712 to the left side wall 912. The left side bracket 1712 also comprises a rack mounting portion 1808, extending perpendicular to the enclosure mounting portion 1804 (i.e. away from the left side wall 912). Defined in the rack mounting portion 1808 is a pair of oblong holes 1810, for securing the side bracket 1712 (and the enclosure 102 to which it is attached) to a frame member 3210 or 3212 of a rack (best shown in FIG. 33A).

Also secured to the rack portion 1808 of the right side bracket 1712 is a cable guide 1720. In the illustrated embodiment, the cable guide 1720 has the general shape of a rectangular loop in which is defined a cut or opening 2020, for allowing a user to position or clamp a cable in the cable guide 1720.

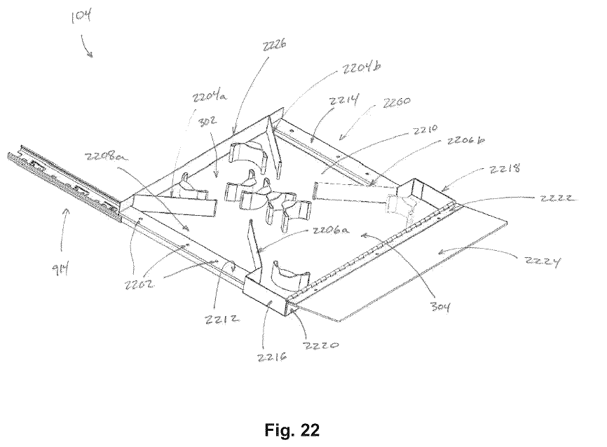

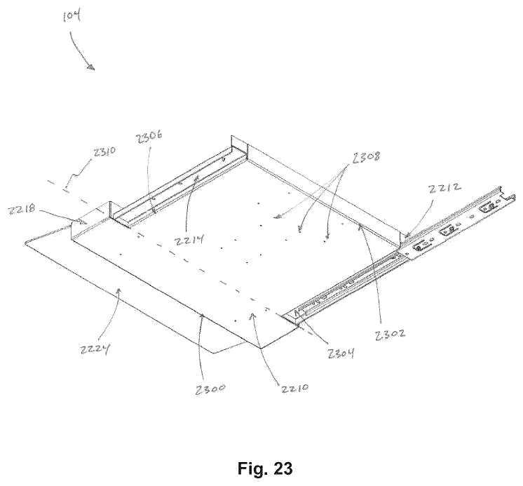

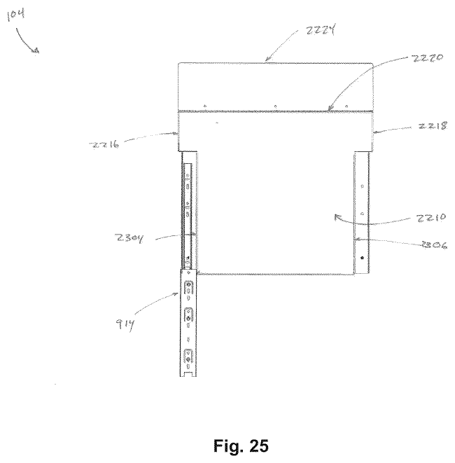

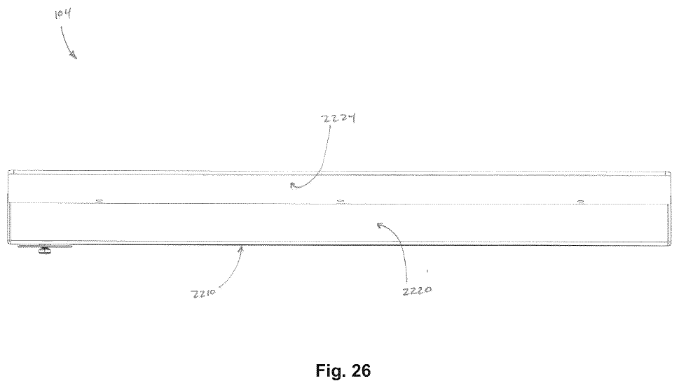

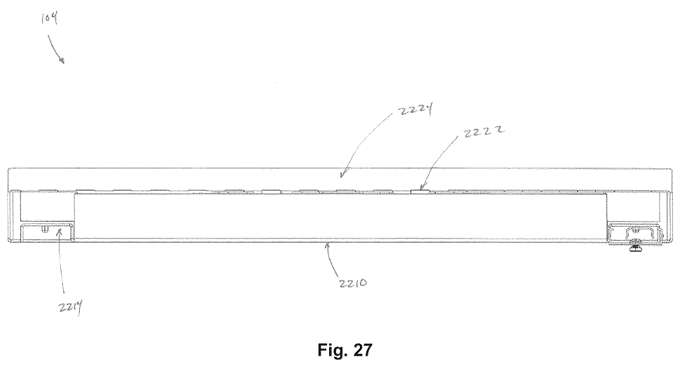

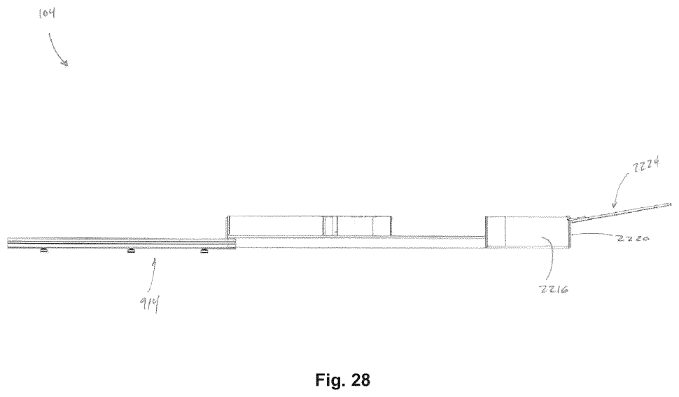

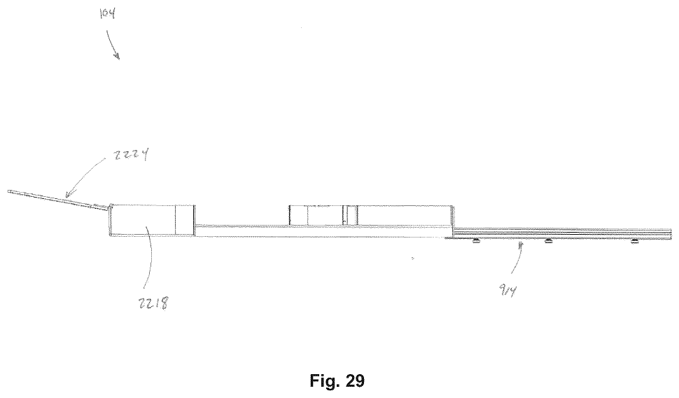

Turning now to FIGS. 22 to 29, the tray 104 will be described. The tray 104 comprises a base plate 2200 secured to the slides 914 using fasteners 2202 (as it will be described in greater details below), two pairs of cable guiding walls 2204a, 2206a and 2204b, 2206b for guiding and constraining the movement of the cables when the tray 104 is moved between the open and closed position, as well as a front set of spooling elements 2400 and a back set of spooling elements 2402 extending upwardly from the base plate 2200, to coil or store the cable, and defining together the cable spooling system 106.

The base plate 2200 comprises a bottom wall 2210 having a front end 2300, a back end 2302 and left and right side ends, 2304, 2306, respectively. Defined in the bottom wall 2210 is a plurality of holes 2308 for receiving therein threaded fasteners (not shown), to secure the front and back sets of spooling elements 2400 and 2402 to the bottom wall 2210, as it will be described in greater details below. Provided at the left and right side ends 2304 and 2306 are slide mounting channels 2212, 2214, for receiving second portions of the left and right slides 914, 916 therein, and securing these second portions of the slides 914, 916 to the base plate 2200. More specifically, the slide mounting channels 2212, 2214 have the general shape of inverted U-shaped channels extending from the back end 2302 of the base plate 2200 to an intermediate location 2310 between the front end 2300 and the back end 2302 (but closer to the front end 2300 than to the back end 2302). As it will be appreciated, the length of the slide mounting channels 2212, 2214 is adapted to generally match the length of the second portions of the slides 914, 916. Defined in the slide mounting channels 2212, 2214 are holes (not shown), for receiving therein fasteners 2202 for fastening the base plate 2200 to the second portions of the slides 914, 916.

Still provided at the left and right side ends 2304, 2306, are left and right walls 2216, 2218, respectively. Left and right side walls 2216, 2218 extend upwardly from, and perpendicularly to the bottom wall 2210, between the intermediate location 2310 and the front end 2300 of the base plate 2210. At the front end 2300, the left and right side walls 2216, 2218 are attached to a front wall 2220, also extending upwardly and perpendicularly to the bottom wall 2210. In the illustrated embodiment, the front wall 2220 is provided with a hinge 2222 to which is secured a pivotable cover 2224, preferably made of a transparent material. The pivotable cover 2224 is pivotable between an open position for allowing access to a portion of the storing space defined in the tray 104 and a closed position for closing this portion of the storing space when the tray 104 is in the retracted position, as this portion of the tray 104 is not covered by the top wall 900 of the enclosure 102 when the tray 104 is in the retracted position (as best shown in FIGS. 32A, 33A and 34A).

Provided at the back end 2302 of the base plate 2200, and extending upwardly from and perpendicularly to the bottom wall 2210, between the slide mounting channels 2212, 2214, is a back wall 2226.

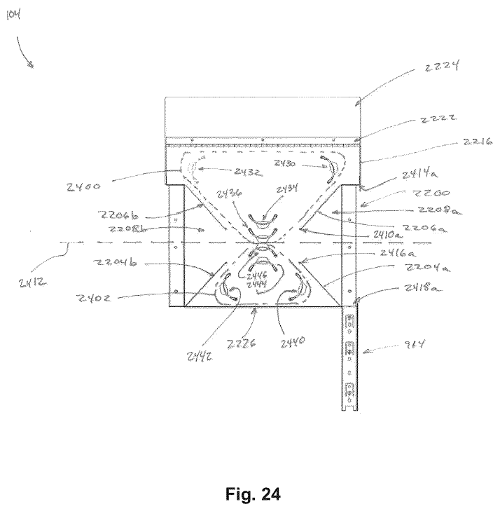

The left and right pairs of guiding walls 2204a, 2206a and 2204b, 2206b being mirror images of one another, only the left pair of guiding walls 2204a, 2206a will be described. As it will be appreciated, a similar description also applies to right pair of guiding walls 2204b, 2206b, with proper adaptation. In one embodiment, the left pair of guiding walls 2204a, 2206a comprises the front guiding wall 2206a and the back guiding wall 2204a. The back and front guiding walls 2204a, 2206a extend upwardly from the bottom wall 2210 of the base plate 2200. When seen from the top (see FIG. 24), the front guiding wall 2206a is doglegged shaped and comprises an inner end 2410a located proximal to a centerline 2412 of the base plate 2200, and an outer end 2414a adjacent to the left wall 2216 of the base plate 2200, at the intermediate location 2310. As such, when seen from the top, the front guiding wall 2206a extends angularly relative to the front wall 2220 and side walls 2216 or 2218. Likewise, the back guiding wall 2204a is doglegged shaped and comprises an inner end 2416a located proximal to the centerline 2412 of the base plate 2200, and an outer end 2418a, proximal to the back wall 2226 and the left end 2304 of the base plate 2200, and prolonging the surface of the back wall 2226 atop the left slide mounting channel 2212. When seen from the top, the back guiding wall 2204a extends angularly relative to the back wall 2226 and the left slide channel 2212. Together, the back and front guiding walls 2204a, 2206a define a funneled opening 2228a having a width narrowing from the left end 2304 of the base plate 2200 toward the inner ends 2416a, 2410a of the back and front guiding walls 2204a, 2206a. As it will become apparent below, the funneled opening 2228a, and the front and back guiding walls 2204a, 2206a, allow a cable extending in the opening 2208a and the left cable guide 1712, to move backwardly and frontwardly in the opening 2208a relative to the base plate 2200 as the tray 104 is moved between the retracted and open positions. In one embodiment, the angle defined between the axis of the centerline 2412 and the front guide wall 2206a is similar to the angle defined between the same axis and the back guide wall 2204a.

As best shown in FIG. 3, the front guiding walls 2206a, 2206b of the left and collaborate with the side walls 2216, 2218 and the front wall 2220 of the base plate 2200 to define a generally trapezoidal front storage compartment 300. Likewise, the back guiding walls 2204a, 2204b collaborate with the back wall 2226 of the base plate 2200 to define a generally triangular storage compartment 302.

Returning to FIG. 24, the front and back sets of spooling elements 2400, 2402 are used to coil or spool cables (fiber patches) in the front and back cable storage compartments 300, 302, respectively.

The front set of spooling elements 2400 comprises left and right spooling elements 2430, 2432 proximal to the front wall 2220 of the base plate 2200 and respectively the left and right side walls 2216, 2218, a front inner central spooling element 2434 and a front outer central spooling element 2436, all in the front storage compartment 300. The front inner and outer central spooling elements are located halfway between the left end 2304 and the right end 2306 of the base plate 2200 (i.e. in the middle of the base plate 2200), but the front inner central spooling element 2434 is located closer to the front wall 2220 than the outer central element 2436, which is closer to the centerline 2412 than the front inner central spooling element 2434. As it will become apparent below, the front outer central element 2436 is positioned such that it can guide the cable coiled in the front storage compartment 300 toward the left and/or front funneled openings 2208a, 2208b.

The back set of spooling elements 2402 is similar and comprises left and right spooling elements 2440, 2442 proximal to the back wall 2226 of the base plate 2200 and respectively the left and right slide receiving channels 2212, 2214, a back inner central spooling element 2444 and a back outer central spooling element 2446, all in the back storage compartment 302. The back inner and outer central spooling elements 2444, 2446 are located halfway between the left end 2304 and the right end 2306 of the base plate 2200 (i.e. in the middle of the base plate 2200), but the inner central spooling element 2444 is located closer to the back wall 2226 than the outer central element 2446, which is located closer to the centerline 2412. As it will become apparent below, the back outer central element 2446 is positioned such that it can guide the cable coiled in the back storage compartment 302 toward the left and/or front funneled openings 2208a, 2208b. In one embodiment, the front and back outer central spooling elements 2436, 2446 collaborate with one another to maintain the cables, whether they are coiled in the front or the back storage compartments 300 or 302, in position proximal to the centerline 2412 of the base plate 2200 such that those cables are in proper alignment with the funneled openings 2208a, 2208b.

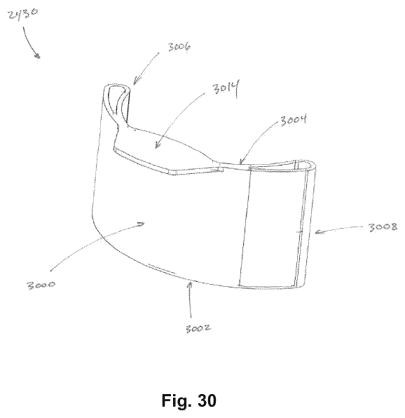

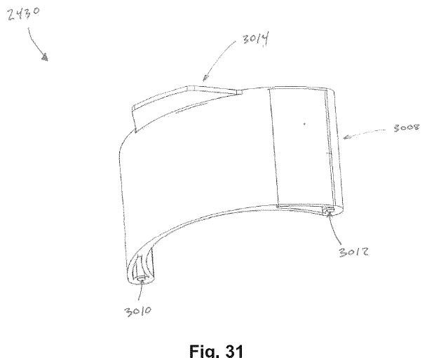

In the illustrated embodiment, the spooling elements are essentially identical, whether they are located in the front storage compartment 300 or the back storage compartment 302. As such, only spooling element 2430 will be described, and it will be appreciated that a similar description also applies to spooling elements 2432, 2434, 2436, 2440, 2442, 2444 and 2446. With reference to FIGS. 30 and 31, the spooling element 2430 comprises a vertically extending curved wall 3000 having a bottom end 3002, a top end 3004 and left and right ends 3006, 3008. The curved wall 3000 defines a curved outer face against which can rest the cable coiled. The radius of the curvature of the curved outer face 3000 is adapted to meet the minimum bend requirements for the cable coiled in the front or back compartments 300 or 302. Provided at each of the left and right ends 3006 and 3008 of the curved wall 3000 are threaded holes 3010, 3012 (best shown in FIG. 31). The shape and size of the curved wall 3000, as well as the position of the threaded holes 3010, 3012, are adapted such that the threaded holes 3010, 3012 align with corresponding holes 2308 in the bottom wall 2210 of the base plate 2200, for securing the spooling element 2430 to the bottom wall 2210 of the base plate 2200 using threaded fasteners (or, conversely, the position of the holes 2308 on the bottom wall 2210 of the base plate 2200 are adapted to match the position of the threaded holes 3010, 3012 on the spooling element 2430). The spooling element 2430 also comprises a horizontal tab 3014, which extends orthogonally to the curved wall 3000 at the top end 3004. The horizontal tab 3014 is configured for preventing unwanted vertical movement of the cable relative to the curved outer surface of the curved wall 3000 when the cable is coiled and maintaining the cable in a proper storage position in the front or back storage compartment 300 or 302. In one embodiment, the curved wall 3000 and the horizontal tab 3014 are made of a unitary construction, for instance from a plastic material.

While in this embodiment, the plurality of spooling elements is secured to the base plate 2200 using threaded fasteners (not shown), it will be understood that other configurations are possible. For instance, the spooling elements 2430, 2432, 2434, 2436, 2440, 2442, 2444 and 2446 could be integrally formed with the base plate 2200 where the base plate 2200 and the spooling elements 2430, 2432, 2434, 2436, 2440, 2442, 2444 and 2446 would be manufactured by plastic injection or otherwise. Further, instead of having front or rear sets 2400, 2402 including multiple spooling elements, the tray 104 could be provided with a single structure (e.g. a molded plastic or metal structure) accomplishing the function of the left, right, inner and outer central spooling elements 2430, 2432, 2434, 2436, 2440, 2442, 2444 and 2446.

Having described the general components of the system 100, its operation will now be described in general terms with reference to FIGS. 32A to 34B. As stated, the tray 104 can be moved between the open position (FIGS. 1 to 9, 32B, 33B and 34B) and the closed position (FIGS. 32A, 33A and 34A). When the tray 104 is in the closed position, a major portion of the tray 104 is contained or received in the enclosure 102, the top wall of the enclosure 102 covering the top of the back storage compartment 302 as well as a portion of the front compartment 300, the remaining portion of the front compartment 300 extending outside the enclosure 102. However, the pivotable cover 2224, in closed position (e.g. FIG. 32A), covers this remaining portion of the front storage compartment 300 (and portions of the funneled openings 2208a and 2208b), as it extends from the front end of the base plate 2200 to a region adjacent to the front end of the top wall of the enclosure 102. Still referring to FIGS. 32A, 33A and 34A, on each side of the tray 104, the left and right funneled openings 2208a, 2208b are partially closed by the side walls 910, 912 of the enclosure 102, but a portion of the funneled openings 2208a, 2208b remain open between the outer end of the front guiding walls 2206a, 2206b and the rack mounting portion 1808 of the side brackets 1712 of the enclosure 102 (which corresponds to the front end of the side wall), thus leaving passages 3200, 3202 for the cable to enter the storage compartments 300, 302 from one of the left and right funneled openings 2208a, 2208b and to exit them from the other of the left and right funneled openings 2208a, 2208b. In one embodiment, the width of these passages 3200, 3202 essentially corresponds to the size of the cable guides 1720 mounted to the rack mounting portion 1808 of the side brackets 1712.

When the tray 104 is moved to the open position (and the pivotable cover 2224 is opened), the front and back storage compartments 300, 302, as well as the top of the left and right funneled openings 2208a, 2208b are located outside the enclosure 102 and are exposed, to facilitate handling of the cable in the front and back storage compartments 300, 302 (e.g. for coiling the cable about the spooling elements 2430, 2432, 2434, 2436, 2440, 2442, 2444 and 2446). In the illustrated embodiment, almost only the back wall 2226 of the base plate 2200, as well as backward portions of the back angular walls 2204a, 2204b remain underneath the top wall 900 of the enclosure 102. As it will be appreciated, the fact that the front and back storage compartments 300, 302, as well as the left and right openings 2208a, 2208b are fully accessible greatly facilitates the work of technicians, for instance to coil cable about the spooling elements 2430, 2432, 2434, 2436, 2440, 2442, 2444 and 2446.

To store a cable in either the front or back storage compartments 300 or 302, the process is essentially the same (e.g. for circular slack management). As such, it will be described and illustrated in connection with the front storage compartment 300, but it will be appreciated that a similar process is also applicable to storing cables in the back storage compartment 302. Also, in some instances, a cable can be stored simultaneously in both the front and back storage compartments 300, 302, for instance in the case of 8 style slack management. In a first step, a first end 502 of the cable 500 is passed through one of the left and right cable guides 1720, into the corresponding funneled opening 2208a or 2208b, and then between the outer central spooling elements 2436 and 2446 of the front and back sets of spooling elements 2400 and 2402, and the cable 500 is pulled through this cable guide 1720 and through the space between the outer central spooling elements 2436, 2446, until a desired or available length is reached. At that point, the cable 500 is coiled about the left, right and inner central spooling elements 2430, 2432, 2434, beneath the horizontal tabs 3014, ensuring that the cable 500 is coiled sufficiently tight to engage the curved walls 3000 of the spooling elements 2430, 2432, 2434, and to remain engaged by the horizontal tabs 3014 if vertical movement of the cable 500 occurs in the front storage compartment 300. Once a proper length of cable 500 has been coiled in about the spooling elements 2430, 2432, 2434 in the front storage compartment 500, the first end 502 of the cable is once again passed in the space defined between the outer central spooling elements 2436, 2446 of the front and back sets of spooling elements 2400, 2402, and pulled through the other of the left and right funneled openings 2208a, 2208b and the cable guide 1720, and pulled until the cable 500 is sufficiently tight.

As it will be appreciated, the left and right cable guides 1720 secured to the side brackets 1712 maintain the cable in a constant frontward/backward position relative to the side brackets 1712 when the tray 104 is moved and, incidentally, relative to the front end 902 of the enclosure 102 and to the vertical frame members 3210, 3212 of the telecommunication equipment rack. While in this embodiment, cable guides 1720 in the form of rectangular loops are used, it will be appreciated that the cable guides could have a different shape. Further, the cable guides could be replaced with other structures or devices to secure the cable to the side brackets or other types of attachment points located generally at corresponding locations (e.g. .zip ties, clamps).

With this configuration, when the tray 104 is in the open position, the cable 500 extends in the left and right funneled openings 2208a, 2208b, generally along the left and right back angular walls 2204, 2204b. When the tray 104 is moved toward the closed position, the top wall 900 and side walls 910, 912 of the enclosure 102 gradually cover the top of the back and front compartments 302, 300 and the left and side openings 2208a, 2208b, while the cable guides 1720 and the outer central spooling elements 2436, 2446 of the front and back sets 2400, 2402 prevent frontward/backward movement of the cable 500 relative to the side brackets 1712 and to the center of the tray 104, respectively. As such, when the tray 104 is moved toward the closed position, it slides freely in the left and right funneled openings 2208a, 2208b, from the back thereof to the front, atop the bottom wall 2210 and the left and right slide mounting channels 2212, 2214. As the tray 104 moves toward the closed position, the outer central spooling elements 2436, 2446 and/or the centerline 2412 reach a point where they are in registry with the left and right cable guides 1720 (i.e. an aligned position). As it will be appreciated, when the tray 104 is in the aligned position, the distance separating the location of the outer central spooling elements 2436 or 2446 and the location left cable guide 1720 is slightly less than the distance separating the location of the outer central spooling elements 2436 or 2446 and the location left cable guide 1720 when the tray 104 is in the fully closed position or the fully open position. As such, when the tray 104 is moved from the open position to the closed position, the movement of the tray 104 induces a slight, gradual, slack in the portions of the cable 500 extending in the funneled openings 2208a, 2208b until they reach the aligned position, at which point further movement of the tray 104 toward the closed position gradually reduces the slack, to reach back the initial tension in the cable 500, in the fully closed position, thanks to the frontward/backward symmetry of the left and right funneled openings 2208a, 2208b. Conversely, when the tray 104 is moved from the fully closed position to the fully open position, the movement of the tray 104 induces the same slight, gradual, slack in the cable 500 portions extending in the funneled openings 2208a, 2208b until they reach the aligned position, at which point further movement of the tray 104 toward the open position gradually reduces the slack to reach back the initial tension in the cable 500, in the fully open position. In this embodiment, the slack induced in the cable 500 is minimal or sufficiently moderate to prevent unwinding of the cable 500 about the spooling elements 2430, 2432, 2434, 2436, 2440, 2442, 2444 and 2446 and/or to impair the proper operation and durability of the cable 500.

While the above description has been made in connection with cable management tray system 100, it will be appreciated that a number of variations are possible without departing from the scope of the invention. For instance, the various walls (e.g. walls 2216, 2218, 2222 and 2226) could be omitted, substituted or be configured differently. Further, the guiding walls 2204a, 2204b, 2206a and/or 2206b could be omitted, substituted or configured differently, for instance by modifying their angle relative to the front wall 2222 or back wall 2226. Also, in some embodiments, the tray 104 could be provided with a single opening on a single side (e.g. only one of openings 2208a and 2208b), for instance when it is desirable to route one end the cables through the front wall or the back wall of the tray, instead of routing it through an opening on the opposed side.

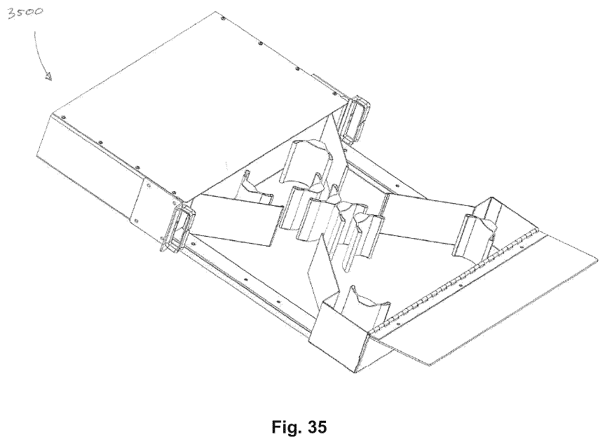

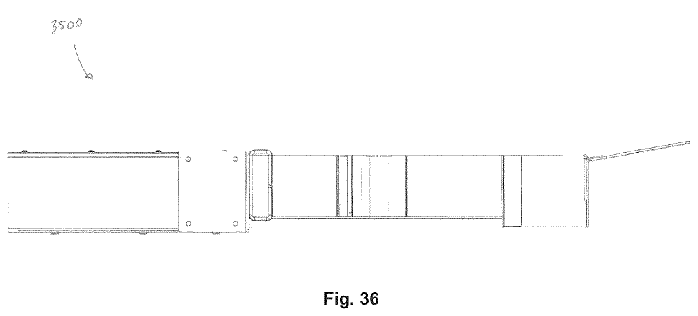

Further, instead of having the general parameters of a 1U system like cable management tray system 100, it could be configured to meet 2U, 4U or any other desired parameters and/or dimensions. For instance, FIGS. 35 and 36 show an alternate embodiment of a cable management tray system 3500 having essentially the same parameters as cable management tray system 100, except for its thickness that meet the 2U requirements or parameters instead of 1U parameters. As such, a single cable management tray system 3500 (2U) tends to offer more coiling and storage space than a cable management tray system 100 (1U).

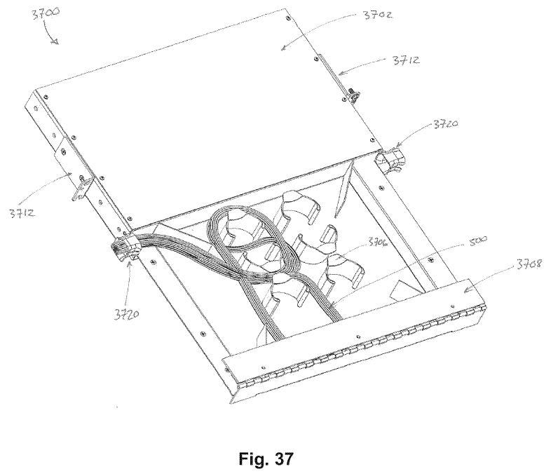

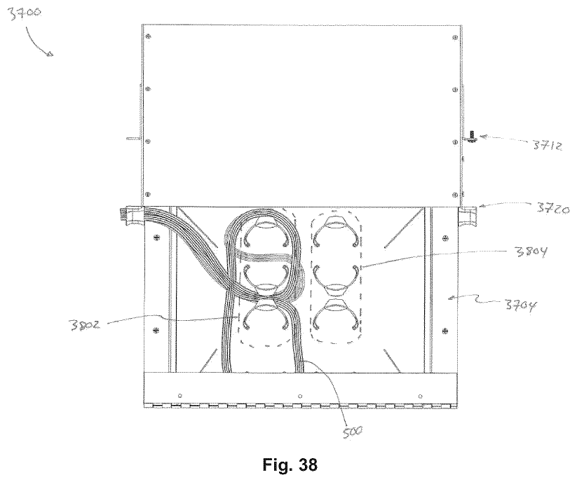

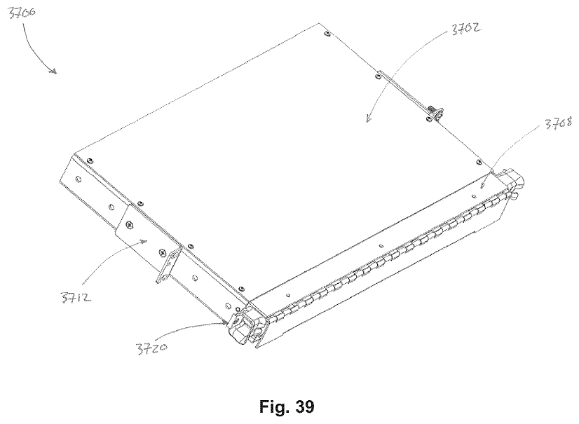

Further, while the cable management tray system 100 has been described in connection with two exemplary storage compartments (i.e. front storage compartment 300 and back storage compartment 302), it will be understood that the tray 104 could comprise a single storage compartment and/or that instead of positioning the spooling elements such that they define a front set of spooling elements 2400 and back set of spooling elements 2402, they could be positioned differently. For instance, with reference to FIGS. 37 to 39, a further alternate embodiment of a cable management tray system 3700 is shown in open position (FIGS. 37 and 38) and in closed position (FIG. 39). In this embodiment, cable management tray system 3700 is provided with an enclosure 3702 and a tray 3704 slidably mounted in the enclosure 3702, as well spooling elements 3706. In this embodiment, the spooling elements are positioned so as to define a left set of spooling elements 3802 and a right set of spooling elements 3804 (best shown in FIG. 38). In such a configuration, it is possible to coil or spool cable lengths that are shorter that with cable management tray systems 100 or 3500.

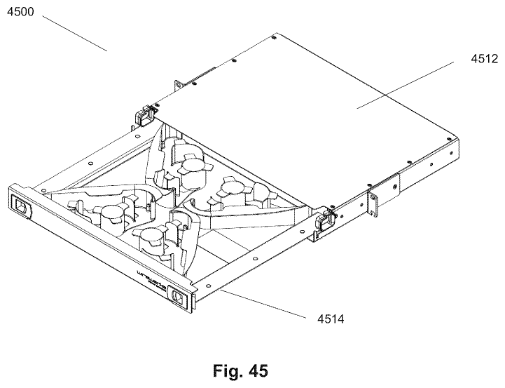

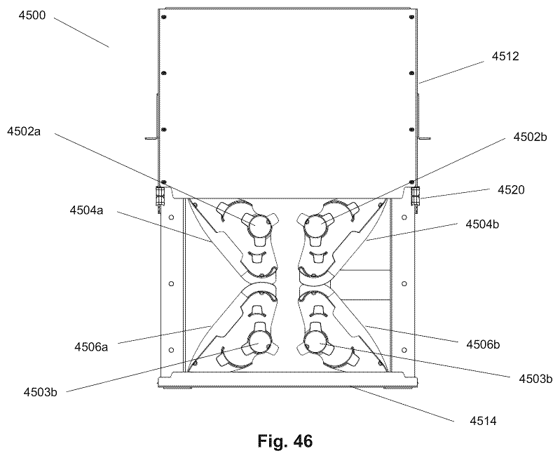

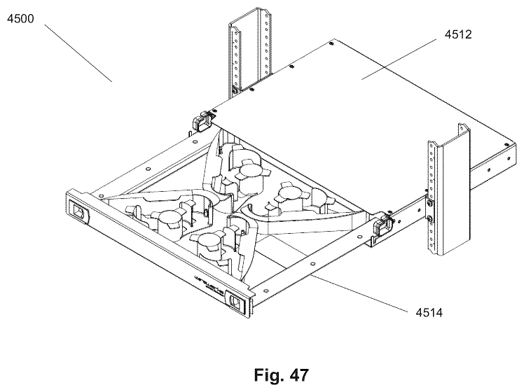

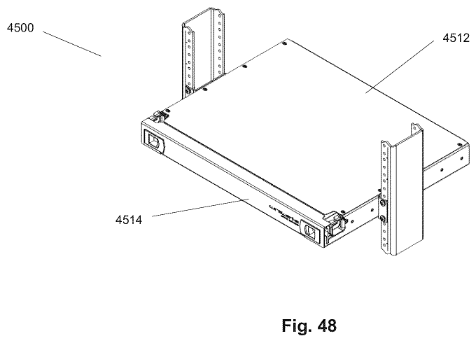

With reference to FIGS. 45 to 48, a further alternative embodiment of a cable management tray 4500 is shown in open position (FIGS. 45 to 47) and in closed position (FIG. 48). In this embodiment, cable management tray system 4500 is provided with enclosure 4512 and tray 4514 slidably mounted in the enclosure 4502. In this embodiment, the routing system comprising spooling elements 4502a, 4502b, 4503a and 4503b arranged in a symmetrical configuration relative to the front-to-back and side-to-side centerlines (best shown in FIG. 46). The tray is also provided with guiding walls 4504a, 4504b, 4506a and 4506b. In this embodiment, tray 4514 is completely contained within enclosure 4512 when in the closed position.

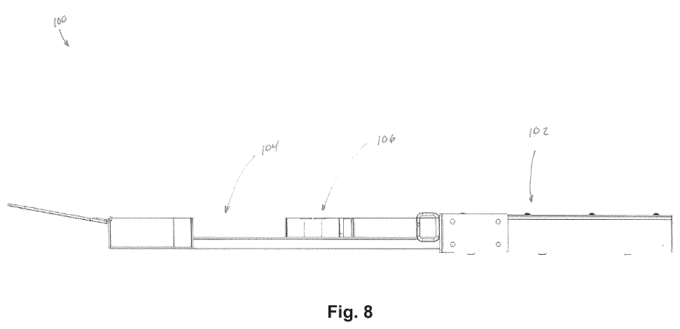

Further, it will be appreciated that the cable lengths stored in the cable management tray systems 100, 3500, 3700 or 4500 can be stored in a number of ways. For instance, the cable can be coiled in a circle configuration, in a FIG. 8 configuration, or otherwise, as shown in FIGS. 37, 40 and 41. As such, it will be appreciated that the various spooling elements (e.g. spooling elements 3706) can be positioned in various configurations to achieve the desired cable routing paths. Further, it will be appreciated that in some embodiments, it may be desirable to have no spooling elements, the cable stored in cable management tray systems 100, 3500, 3700 or 4500 simply resting on top of the bottom wall of the tray. In such an embodiment, the cable management tray systems can be provided only with central routing elements (for instance similar to outer central spooling elements 2436, 2446 and/or achieving a similar function), so as to maintain a portion of the cable stored on the tray proximal to the centerline location when the tray is moved between the open and the closed position. Conversely, the outer central spooling elements 2426 or 2446 play the functions of central routing elements.

Further, as it will be appreciated from FIGS. 37 to 39, the dimensions of the enclosure 3702 and of a pivotable cover 3708 are different than those of cable management tray systems 100 or 3500, and cable guides 3720 are mounted directly to the front end of the side walls of the enclosure 3702, the side brackets 3712 being located rearwardly on the side wall of the enclosure 3702 as compared to the side brackets 1712 of cable management tray system 100 (and 3500). As it will be appreciated, the position of the side brackets (e.g. 1712 or 3712) can be positioned anywhere on the side wall of the enclosure so as to allow a proper positioning of the cable management tray system on a rack or panel.

Also, it will be appreciated that a number of configurations of enclosures (e.g. enclosures 102 or 3702) are possible, without departing from the scope of the invention. For instance, instead of being connected to one another via a top wall (e.g. top wall 900 of enclosure 102), the side walls (e.g. side walls 910, 912) could be attached to one another via a bottom wall. Further, the side walls could be connected to one another via one or multiple cross-members, secured to the top and/or the bottom of the side walls, and extending orthogonally thereto to connect the side walls (e.g. rod-shaped cross-members). Further, the enclosure could have no bottom wall, no top wall and no cross-members, the side walls being maintained in position relative to one another by the tray (e.g. the tray 104) and the slides (e.g. slides 914) attached thereto, and/or by the structure (e.g. the telecommunication equipment rack) to which the cable management tray system 100, 3500, 3700 or 4500 is secured.

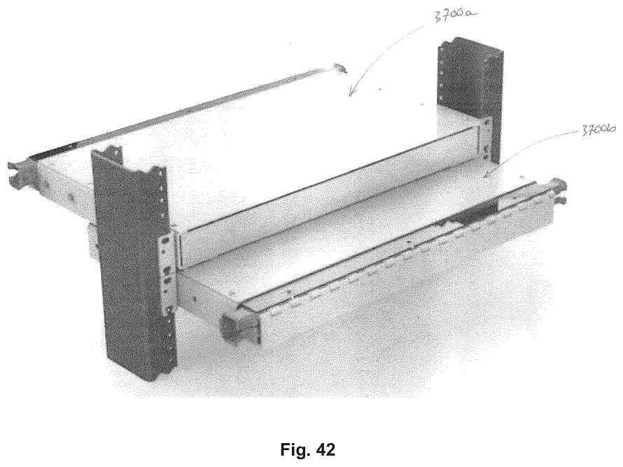

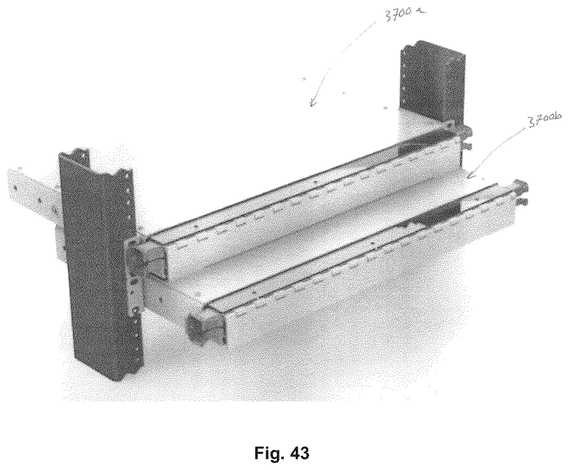

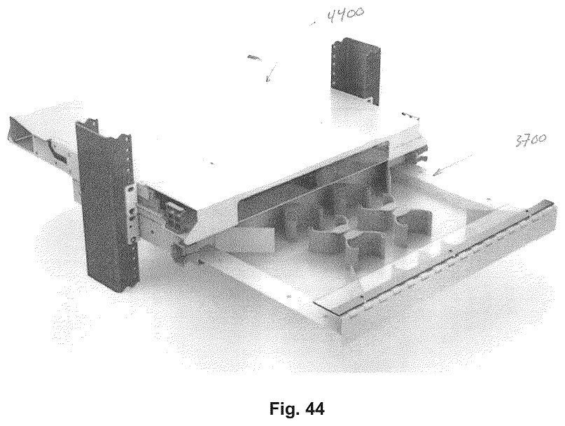

While in the above embodiments, the cable management tray systems 100, 3500 and 3700 have been described in connection with telecommunication equipment racks, it will be understood that they could be mounted to a great variety of suitable structures, such as shelves, wall fixtures, and the like. Further, it will be appreciated that cable management tray systems 100, 3500, 3700 and/or 4500 could be mounted in a number of ways. For instance, the side brackets 3712 could be mounted to the side walls of the enclosures such that the front ends of two cable management tray systems 3700a and 3700b mounted to a rack on top of one another face opposite directions (see FIG. 42). Alternatively, two or more cable management tray systems could be mounted on top of one another, with their front ends facing in the same direction, but in a staggered arrangement (FIG. 43). Also, as it will be appreciated, a cable management tray system 3700 can be mounted to a rack together with other types of telecommunication equipment 4400 (see FIG. 44), and that a number of other possible combinations and permutations are possible.

The embodiments described above are intended to be exemplary only. The scope of the invention is therefore intended to be limited solely by the appended claims.

We claim:

1. A cable management tray system comprising:
a. an enclosure comprising a first side wall and a second side wall, each of the first and second side walls having a front end and a back end;
b. a first cable guide and a second cable guide, each said cable guide being configured to guide a portion of the cable; and
c. a tray slidably mounted to the enclosure and movable between an open position and a closed position, the tray having a front end, a back end, a first side and a second side, the tray comprising:
i. a bottom wall;
ii. a routing system comprising one or more spooling elements mounted on the bottom wall, the routing system being configured to retain a portion of a cable length received on the tray when the tray is moved between the open and the closed position; and
iii. a first cable opening extending along the first side of the tray and a second cable opening extending along the second side of the tray, each of the first and second cable openings extending between the front end and the back end of the tray, each cable opening allowing a portion of the cable length to extend from the routing element to a respective cable guide to slide relative to the front end and back end as the tray is moved between the open position and the closed position.

2. The cable management tray system of claim 1, wherein the first cable guide is mounted to the first side wall of the enclosure and the second cable guide is mounted to the second side wall of the enclosure, wherein each said cable guide defines the front end of the respective side wall.

3. The cable management tray system of claim 1 or 2, wherein the routing system is located in a generally central location within the tray.

4. The cable management tray system of any one of claims 1 to 3, wherein the routing system is centered on an area that corresponds generally to a midpoint of the tray translation, wherein the tray translation is the distance traveled by the tray between open and closed positions.

5. The cable management tray system of any one of claims 1 to 4, wherein at least one of the one or more spooling elements are located proximal to a centerline location between the front end and the back end.

6. The cable management tray system of any one of claims 1 to 5, wherein the spooling elements are arranged in a symmetrical configuration relative to a centerline extending fom the front end to the back end of the tray.

7. The cable management tray system of any one of claims 1 to 6, wherein the spooling elements are arranged in a symmetrical configuration relative to a line extending from the first side to the second side of the tray.

8. The cable management tray system of any one of claims 1 to 6, wherein the tray further comprises two pairs of cable guiding walls configured to guide and constrain movement of the cables when the tray is moved between the open and closed position.

9. The cable management tray system of claim 8, wherein a first pair of cable guiding walls is located adjacent to the back end of the tray and a second pair cable guiding walls is located adjacent to the front end of the tray, wherein each guiding wall extends inwardly from the general area of a respective corner of the tray, toward the central area of the tray.

10. The cable management tray system of any one of claims 1 to 9, wherein when the tray is in the closed position, the entire tray is contained within the enclosure.

11. The cable management tray system of any one of claims 1 to 9, wherein when the tray is in the closed position, a major portion of the tray is contained within the enclosure.

12. The cable management tray system of claim 11, wherein the portion of the tray that is not contained within the enclosure is covered by a tray cover.

13. The cable management tray system of claim 12, wherein the tray cover is pivotably mounted to the tray.

14. The cable management tray system of any one of claims 1 to 13, wherein the enclosure is configured to be mounted on a structure.

15. The cable management tray system of claim 14, wherein the structure is a telecommunication equipment rack.

16. The cable management tray system of claim 15, wherein the telecommunication equipment rack is one of a 19-inch telecommunication equipment rack and a 23-inch telecommunication equipment rack.

17. The cable management tray system of any one of claims 1 to 16, wherein the cable management tray system is configured for use with a fiber cable.
